(19) United States
(12) Patent Application Publication
(10) Pub. No.: US 2014/0310640 A1
(43) Pub. Date: Oct. 16, 2014

(54) INTERACTIVE DIGITAL ART APPARATUS

(71) Applicant: ELECTRONICS AND TELECOMMUNICATIONS RESEARCH INSTITUTE, Daejeon-city (KR)

(72) Inventors: Yong-Sun KIM, Daejeon (KR); Yong-Wan KIM, Daejeon (KR); Ung-Yeon YANG, Daejeon (KR); Ki-Hong KIM, Daejeon (KR); Jin-Ho KIM, Daejeon (KR)

(73) Assignee: ELECTRONICS AND TELECOMMUNICATIONS RESEARCH INSTITUTE, Daejeon-city (KR)

(21) Appl. No.: 14/193,041

(22) Filed: Feb. 28, 2014

(30) Foreign Application Priority Data
Apr. 10, 2013 (KR) 10-2013-0039091

(51) Int. Cl. G06F 3/0484

(52) U.S. Cl. CPC G06F 3/0484
USPC 715/780

(57) ABSTRACT

Disclosed herein is an interactive digital art apparatus. The interactive digital art apparatus includes a display unit, an input interface unit, a posture tracking unit, and a processing unit. The display unit visualizes a virtual canvas. The input interface unit is manipulated by a user, and outputs input interface information attributable to an action in which the user draws a picture on the virtual canvas in front of the display unit. The posture tracking unit tracks a direction in which the face of the user is directed, and the posture of the input interface unit. The processing unit draws a picture on the virtual canvas based on the input interface information, the direction in which the face of the user is directed, and the posture of the input interface unit.

### CROSS REFERENCE TO RELATED APPLICATION

This application claims the benefit of Korean Patent Application No. 10-2013-0039091, filed on Apr. 10, 2013, which is hereby incorporated by reference in its entirety into this application.

### BACKGROUND OF THE INVENTION

1. Technical Field

The present invention relates generally to an interactive digital art apparatus and, more particularly, to an information technology (IT)-based interactive digital art apparatus using a virtual canvas.

2. Description of the Related Art

Since drawing a picture on a canvas or applying graffiti onto a wall is temporary, the reproducibility thereof is very poor, the maintenance of the value thereof is limited, and it is difficult to share the results thereof with other people. Additionally, in the case of percussion musical instruments, since they are voluminous and produce loud sounds, it is difficult to play them in daily life.

In the meantime, with the development of IT technology, the demands for virtual graffiti, virtual painting and virtual performance have increased.

Korean Patent Application Publication No. 2011-0071211 discloses a virtual scribbling system and an interface thereof that is capable of, through digital technology, repeatedly reproducing a disposable artistic performance and sharing it online.

The virtual scribbling system disclosed in Korean Patent Application Publication No. 2011-0071211 includes a spray can interface configured to generate interface information in response to the painting operation of a user, a camera configured to track the painting operation of the user, and a processing unit configured to analyze the interface information and the tracked painting operation and output a painting image based on the painting operation of the user based on the results of the analysis.

The technology disclosed in Korean Patent Application Publication No. 2011-0071211 uses only a spray can as an input interface.

Korean Patent Application Publication No. 2011-0057955 discloses a virtual painting simulator and a painting pattern representation method thereof in which an actual painting pattern is virtually represented in real time.

The virtual painting simulator disclosed in Korean Patent Application Publication No. 2011-0057955 includes an operation input unit configured to output operation signals based on the virtual painting operation of a user, a pattern processing unit configured to output successive pattern signals obtained by temporally and spatially correcting the operation signals while referring to a plurality of pieces of measurement information, and a display device configured to display the virtual painting operation of the user based on the pattern signals on a 3D virtual structure.

In addition, Korean Patent Application Publication No. 2001-0076489 discloses a virtual performance apparatus and method using a sensor that detect the operation of a user and generate an appropriate medium.

The virtual performance apparatus disclosed in Korean Patent Application Publication No. 2001-0076489 includes a selection unit configured to select a piece of music to be played from among a plurality of pieces of stored music, a tap sensor configured to detect the strength and tempo of the taps that are made by a user, a music playing unit configured to generate an accompaniment based on the melody of selected music, control the tempo and sound strength of the music in accordance with a control signal, and then output the music, a graphic display unit configured to visualize and display current music information in the form of graphics, a music playing unit configured to receive a selection signal, read data of corresponding music from memory and output the data to the music playing unit, and a central control unit configured to receive a sensor signal and control the music playing unit and the graphic display unit.

The technology disclosed in Korean Patent Application Publication No. 2001-0076489 is problematic in that there is the inconvenience in which a user should wear the sensor, and touch should be used.

### SUMMARY OF THE INVENTION

Accordingly, the present invention has been made keeping in mind the above problems occurring in the conventional art, and an object of the present invention is to provide an interactive digital art apparatus, which enables various artistic activities, such as making a painting, a drawing, a sketch, graffiti, etc. on a virtual canvas, to be performed, and also enables the virtual performance of a musical instrument to be made using a user interface.

Another object of the present invention is to provide an interactive digital art apparatus, which enables artistic works to be repeatedly reproduced, enables multiple people to perform collaborative work, and allows results to be shared with other people online.

In accordance with an aspect of the present invention, there is provided an interactive digital art apparatus, including a display unit configured to visualize a virtual canvas; an input interface unit configured to be manipulated by a user, and to output input interface information attributable to an action in which the user draws a picture on the virtual canvas in front of the display unit; a posture tracking unit configured to track a direction in which the face of the user is directed, and the posture of the input interface unit; and a processing unit configured to draw a picture on the virtual canvas based on the input interface information, the direction in which the face of the user is directed, and the posture of the input interface unit.

The processing unit may calculate coordinates at which the picture will be drawn on the virtual canvas based on the direction in which the face of the user is directed and the posture of the input interface unit, may simulate an image drawn in accordance with the input interface information, and may then change image pixel values of the virtual canvas.

The processing unit may recognize the picture drawn on the virtual canvas, and may display a 3D model corresponding to the recognized picture on the virtual canvas, thereby enabling the user to interact with the 3D model.

The processing unit may include a recognition unit configured to recognize the picture drawn on the virtual canvas; a 3D model storage unit configured to store the 3D model that matches the picture; and an interaction unit configured to move the 3D model as the user touches the 3D model on the virtual canvas.

The interactive digital art may further include a Graphic User Interface (GUI) provision unit configured to include a plurality of menu options and to display the plurality of menu options on the virtual canvas in response to a request from the user.

The plurality of menu options may include menu options for the replacement of paint, varnish, spray color and background color, and the storage, printing, e-mail transmission, mobile terminal multimedia transmission and website posting of results.

The processing unit may visualize a musical instrument user interface on the virtual canvas, and may enable a virtual musical instrument performance.

The processing unit may include a musical instrument user interface provision unit configured to provide the musical instrument user interface to the virtual canvas; and an interaction unit configured to interact as the input interface unit or the user touches the musical instrument user interface.

The display unit, the posture tracking unit and the processing unit may be installed on a movable stand whose height can be adjusted.

The posture tracking unit may be installed on the upper part of the movable stand, and the posture tracking unit may be slantingly installed such that the posture tracking unit can monitor an area in front of the display unit.

The input interface unit may be implemented as mockups having brush, roller, stick and spray can shapes.

The posture tracking unit may include one or more of an infrared camera, a visible camera, and an ultrasonic sensor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an interactive digital art apparatus according to an embodiment of the present invention;

FIGS. 2 and 3 are diagrams illustrating examples in which the digital art apparatus according to the embodiment of the present invention interactive is installed;

FIG. 4 is a diagram illustrating the combination of two digital art apparatuses;

FIG. 5 is a diagram illustrating an example of the internal configuration of the processing unit illustrated in FIG. 1;

FIG. 6 is a diagram illustrating another example of the internal configuration of the processing unit illustrated in FIG. 1; and

FIG. 7 is a diagram illustrating an interactive digital art apparatus according to another embodiment of the present invention, which is capable of the virtual performance of a musical instrument.

### DESCRIPTION OF THE PREFERRED EMBODIMENTS

First, the term “digital art” described herein may be understood as generally referring to a work of art or artistic work in which digital technology is utilized as a core of creative work. The term “interactive digital art” may be understood as generally referring to the work of adjusting interactions between a human and a work of art using digital technology, thereby enabling them to interact with each other. Accordingly, the term “interactive digital art apparatus” described herein may be viewed as referring to an apparatus that is capable of performing the above-described interactive digital art.

An interactive digital art apparatus according to the present invention will be described with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

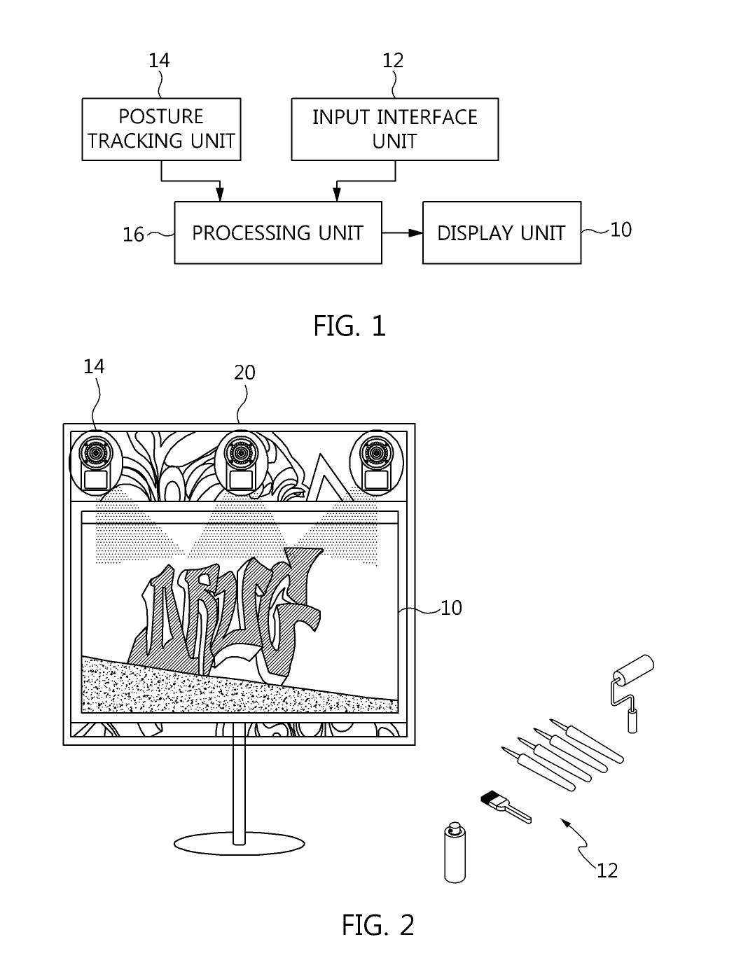

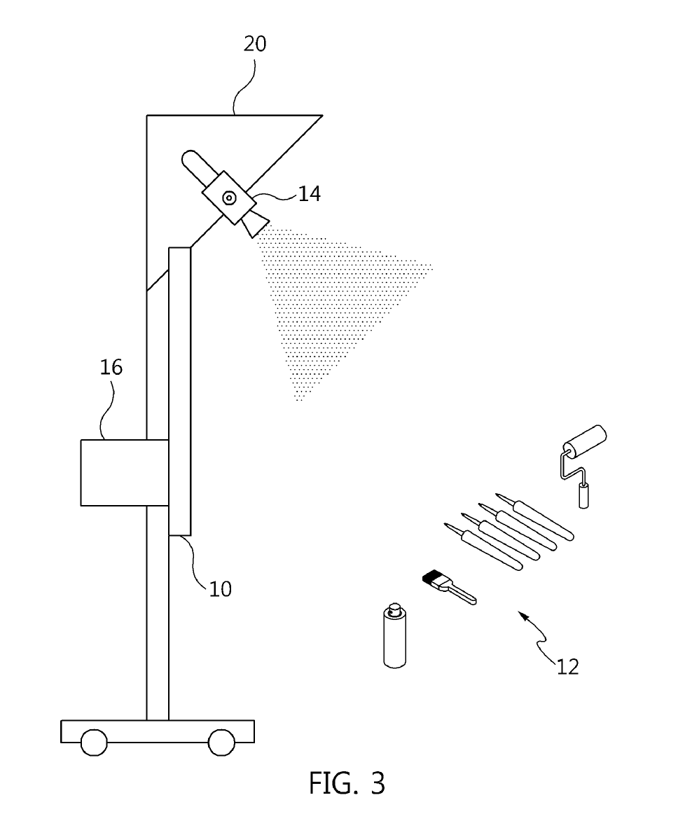

FIG. 1 is a block diagram illustrating an interactive digital art apparatus according to an embodiment of the present invention, and FIGS. 2 and 3 are diagrams illustrating examples in which the digital art apparatus according to the embodiment of the present invention interactive is installed.

The interactive digital art apparatus according to the embodiment of the present invention includes a display unit 10, an input interface unit 12, a posture tracking unit 14, and a processing unit 16.

The display unit 10 visualizes a virtual canvas configured to enable a picture (e.g., painting, a drawing, sketch, graffiti, etc.) to be drawn thereon and to be implemented in virtual space, and enables multi-touch to be applied thereto. The display unit 10 employs a 3D display, and may recognize both single touches and multi-touches. The display unit 10 that visualizes a virtual canvas and enables a user to draw a picture enables a multi-touch function and supports various methods of enabling a user to intuitively input data. Meanwhile, the display unit 10 may enhance a sense of immersion in conjunction with a glass display or a head mount display (HMD). The display unit 10 may be installed in a movable stand 20, as illustrated in FIG. 2 or 3. In this case, the height of the movable stand 20 may be adjusted.

The input interface unit 12 outputs input interface information attributable to an action in which a user draws a picture on the virtual canvas in front of the display unit 10 (that is, in a direction where the virtual canvas can be viewed). That is, when a user performs an action of drawing a predetermined picture while holding the input interface unit 12, the input interface unit 12 outputs input interface information corresponding thereto. The input interface unit 12 may be implemented as various mockups having various shapes, such as brush, roller, stick and spray can shapes. If the input interface unit 12 is a mockup having a brush or roller shape, input interface information (for example, input interface parameters) may include information about pressing force, the mix of water, etc. Alternatively, if the input interface unit 12 is a mockup having a spray can shape, the input interface information (for example, input interface parameters) may include pressure applied to a spray can, the mix of air, etc. Alternatively, if the input interface unit 12 is a mockup having a stick shape, the input interface information (for example, input interface parameters) may include information about force applied when a user hits or beats an object with the stick.

The posture tracking unit 14 tracks the direction in which the face of a user is directed (in particular, the direction in which the gaze of a user is directed) and the posture of the input interface unit 12. In this case, the direction in which the face of the user is directed is required to determine the direction from which the user views the display unit 10. The degree of lateral or vertical rotation of a background visualized on the virtual canvas may vary depending on the direction in which the user views the display unit 10. The posture of the input interface unit 12 includes a trajectory that is generated when the user moves the input interface unit 12 while holding it. For example, the posture tracking unit 14 may include at least one of an infrared camera, a visual camera, an ultrasonic sensor. It may be preferred that the posture tracking unit 14 be installed on the upper part of the movable stand 20, that is, above the display unit 10, as illustrated in FIG. 2 or 3, and be slantingly installed so that it can monitor an area in front of the display unit 10.

The processing unit 16 draws a picture on the virtual canvas based on the input interface information, the direction in which the face of the user is directed, and the posture of the input interface unit 12. The processing unit 16 performs the tasks of calculating coordinates at which the picture will be drawn on the virtual canvas based on the 3D coordinates of the virtual canvas, the direction in which the face of the user is directed, and the posture of the input interface unit 12, simulating an image drawn in accordance with the input interface information, and changing pixel values of the image on the virtual canvas. In this case, the simulation of the image may include a weighted sum based on the mix of various colors, the adjustment of transparency based on an alpha value, the slipping down of paint or varnish attributable to gravity, etc. The processing unit 16 may determine the point of the virtual canvas that a user is viewing based on the direction in which the face of the user is directed, and may determine the points of the virtual canvas at which the picture will be drawn and the way that the picture will be drawn based on the 3D coordinates of the virtual canvas and the posture of the input interface unit 12.

The processing unit 16 is installed on the movable stand 20, preferably behind the display unit 10, as illustrated in FIG. 3.

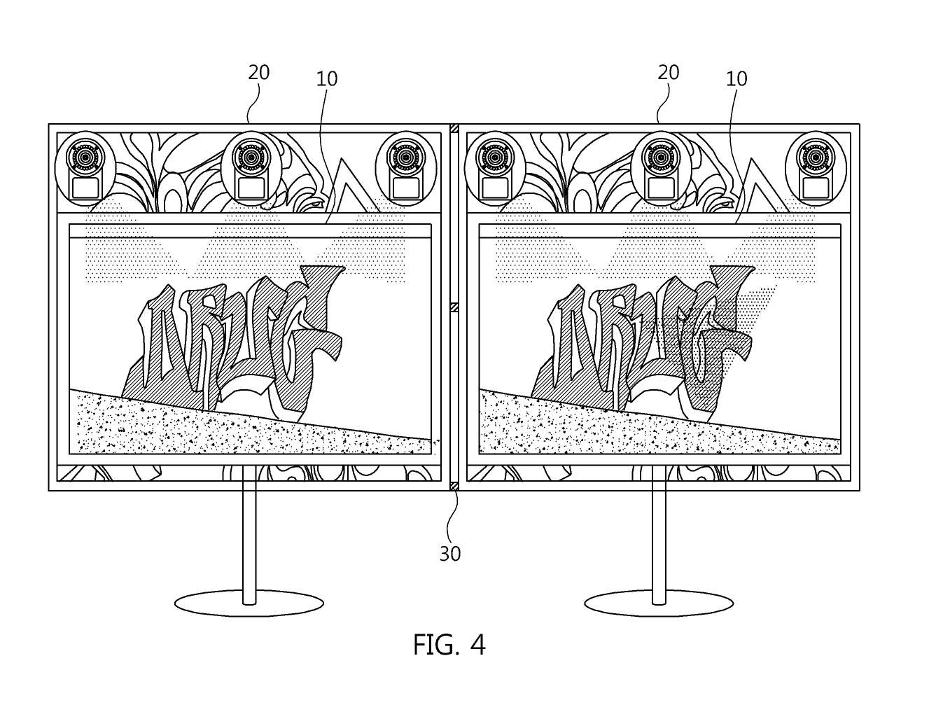

Meanwhile, two interactive digital art apparatuses according to the embodiment of the present invention may be combined with each other and then used, as illustrated in FIG. 4. In this case, a plurality of users may work on a single virtual canvas at the same time.

The case of FIG. 4 may be implemented by using fastening members, such as coupling parts 30, between the two interactive digital art apparatuses. Furthermore, if the two apparatuses are combined with each other, as illustrated in FIG. 4, two processing units may be operated in conjunction with each other, and any of the two processing units may act as a main processing unit.

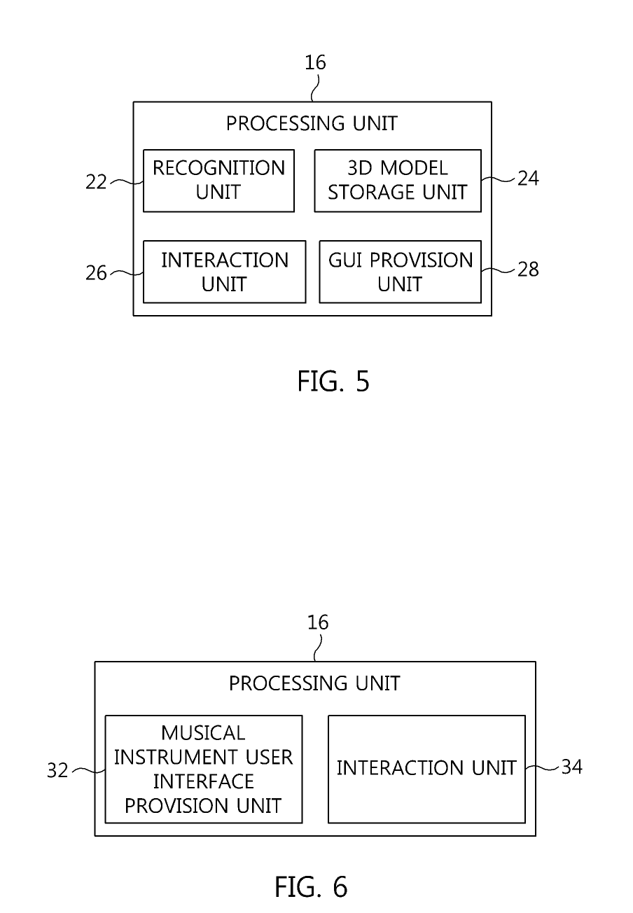

Meanwhile, the processing unit 16 may provide the function of recognizing the picture of the user and interacting with a corresponding 3D model. For this purpose, the processing unit 16 includes a recognition unit 22, a 3D model storage unit 24, and an interaction unit 26, as illustrated in FIG. 5.

The recognition unit 22 recognizes the picture drawn on the virtual canvas of the display unit 10. For example, the recognition unit 22 may be a camera that is installed separately from the posture tracking unit 14.

The 3D model storage unit 24 stores a 3D model that matches the picture drawn on the virtual canvas. That is, since various types of 3D models have been previously stored in the 3D model storage unit 24, the processing unit 16 may search for the 3D model that matches the picture that is recognized by the recognition unit 22.

The interaction unit 26 moves the 3D model as the user touches the 3D model on the virtual canvas. For example, if the 3D model of the virtual canvas is a butterfly and the user touches the butterfly, the interaction unit 26 may create a motion in which the butterfly is fluttering.

As described above, the processing unit 16 recognizes a picture drawn on the virtual canvas through the recognition unit 22, searches for a 3D model corresponding to the picture in the 3D model storage unit 24, and displays the 3D model on the virtual canvas, thereby enabling the user to interact with the 3D model.

Furthermore, the processing unit 16 may include the function of creating a Graphic User Interface (GUI) that shows a menu on the virtual canvas. For this purpose, the processing unit 16 may include a GUI provision unit 28, as illustrated in FIG. 5.

The GUI provision unit 28 includes a plurality of menu options, and displays a plurality of menu options on the virtual canvas in response to a request from the user. For example, the plurality of menu options may include menu options for the replacement of paint, varnish, spray color and background color, and the storage, printing, e-mail transmission, mobile terminal multimedia transmission and website posting of results.

Accordingly, the processing unit 16 may receive the replacement of paint, varnish, spray color or background color or the storage, printing, e-mail transmission, mobile terminal multimedia transmission and website posting of results. That is, when the user selects one menu option from among the menu options displayed on the virtual canvas, a signal corresponding to the menu option is transmitted to the processing unit 14 as an input signal.

After artistic work has been done, the processing unit 16 stores results, and transmits the results through e-mail transmission or multimedia transmission via a mobile terminal or uploads the results to a website, thereby sharing the results with other people. This enables the results of the work of many users to be viewed at a dedicated website, and supports use for a contest. Furthermore, results may be immediately printed, and may be used to manufacture a postcard or clothes.

Meanwhile, the processing unit 16 may visualize a musical instrument user interface on the virtual canvas, and may enable a virtual musical instrument performance. For this purpose, the processing unit 16 may include a musical instrument user interface provision unit 32, and an interaction unit 34, as illustrated in FIG. 6.

The musical instrument user interface provision unit 32 may provide a musical instrument user interface desired by the user to the virtual canvas.

The interaction unit 34 is configured to react as the input interface unit 12 or user touches the musical instrument user interface.

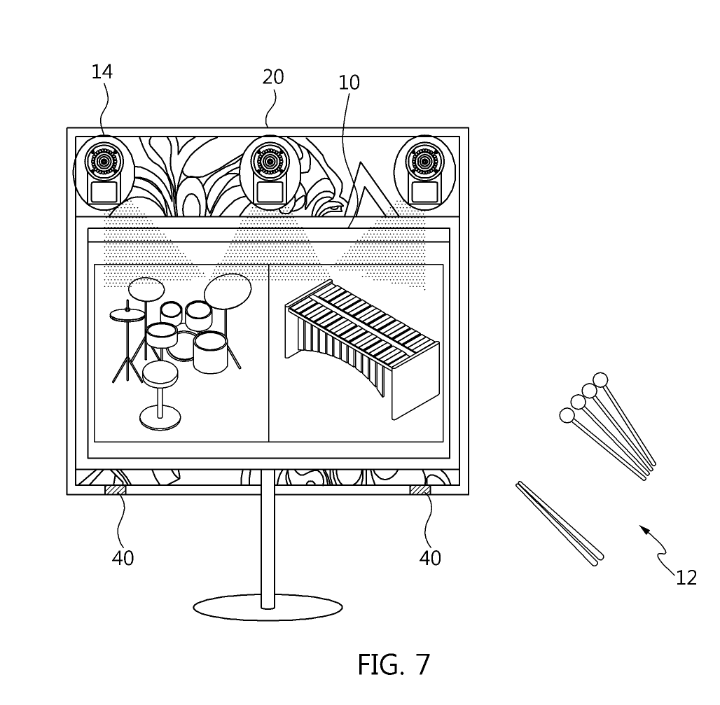

For example, the processing unit 16 may visualize a musical instrument (for example, drum, xylophone, or the like) user interface on the virtual canvas of the display unit 10 via the musical instrument user interface provision unit 32, as illustrated in FIG. 7. In this case, the user may virtually play a musical instrument while holding the interface mockup of the musical instrument, that is, the input interface unit 12, such as a drum stick or a xylophone stick. It will be apparent that the user may virtually play the musical instrument directly through touching. Although a speaker 40 that outputs musical instrument sounds attributable to the playing of the musical instrument is illustrated as being installed on the lower end part of the movable stand 20 in FIG. 7, the location of the installation of the speaker 40 may vary if necessary.

The present invention has the advantage of enabling the user to perform painting to the same extent as if the user drawn a picture on an actual canvas or applied paint or graffiti onto a wall.

The present invention has the advantage of preventing harm from occurring because of the toxicity of actual paint, enabling the user to repeatedly draw a picture without the additional cost of consumables, and providing excellent reproducibility.

In the case of a virtual musical instrument, the present invention has the advantage of enabling the user to virtually play the virtual musical instrument in a daily life space, such as a house, without an actual voluminous, expensive musical instrument.

Furthermore, the present invention has the advantage of enabling experts to perform artistic work, and enabling general persons to easily handle pictures, graffiti, various musical instruments, etc. In particular, in the case of painting, the present invention may be used in the coloring exercise of infants and children because the interactive digital art apparatus according to the present invention is harmless to the human body, and may be also used in the musical education through performance.

Moreover, the present invention has the advantage of facilitating the sharing of user-created results with other people and the advantage of storing, transmitting or printing the results in desired form and then providing a customized service.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An interactive digital art apparatus, comprising:
a display unit configured to visualize a virtual canvas;
an input interface unit configured to be manipulated by a user, and to output input interface information attributable to an action in which the user draws a picture on the virtual canvas in front of the display unit;
a posture tracking unit configured to track a direction in which a face of the user is directed, and a posture of the input interface unit; and
a processing unit configured to draw a picture on the virtual canvas based on the input interface information, the direction in which the face of the user is directed, and the posture of the input interface unit.

2. The interactive digital art apparatus of claim 1, wherein the processing unit calculates coordinates at which the picture will be drawn on the virtual canvas based on the direction in which the face of the user is directed and the posture of the input interface unit, simulates an image drawn in accordance with the input interface information, and then changes image pixel values of the virtual canvas.

3. The interactive digital art apparatus of claim 1, wherein the processing unit recognizes the picture drawn on the virtual canvas, and displays a 3D model corresponding to the recognized picture on the virtual canvas, thereby enabling the user to interact with the 3D model.

4. The interactive digital art apparatus of claim 3, wherein the processing unit comprises:
a recognition unit configured to recognize the picture drawn on the virtual canvas;
a 3D model storage unit configured to store the 3D model that matches the picture; and
an interaction unit configured to move the 3D model as the user touches the 3D model on the virtual canvas.

5. The interactive digital art apparatus of claim 1, further comprising a Graphic User Interface (GUI) provision unit configured to include a plurality of menu options and to display the plurality of menu options on the virtual canvas in response to a request from the user.

6. The interactive digital art apparatus of claim 5, wherein the plurality of menu options comprises menu options for replacement of paint, varnish, spray color and background color, and storage, printing, e-mail transmission, mobile terminal multimedia transmission and website posting of results.

7. The interactive digital art apparatus of claim 1, wherein the processing unit visualizes a musical instrument user interface on the virtual canvas, and enables a virtual musical instrument performance.

8. The interactive digital art apparatus of claim 7, wherein the processing unit comprises:
a musical instrument user interface provision unit configured to provide the musical instrument user interface to the virtual canvas; and
an interaction unit configured to interact as the input interface unit or the user touches the musical instrument user interface.

9. The interactive digital art apparatus of claim 1, wherein the display unit, the posture tracking unit and the processing unit are installed on a movable stand whose height can be adjusted.

10. The interactive digital art apparatus of claim 9, wherein the posture tracking unit is installed on an upper part of the movable stand, the posture tracking unit being slantingly installed such that the posture tracking unit can monitor an area in front of the display unit.

11. The interactive digital art apparatus of claim 1, wherein the input interface unit is implemented as mockups having brush, roller, stick and spray can shapes.

12. The interactive digital art apparatus of claim 1, wherein the posture tracking unit comprises one or more of an infrared camera, a visible camera, and an ultrasonic sensor.
